(19) United States
(12) Patent Application Publication
(10) Pub. No.: US 2006/0103603 A1
(43) Pub. Date: May 18, 2006

(54) Plasma display panel

(75) Inventors: Chong-Gi Hong, Suwon-si (KR); Tae-Kyoung Kang, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/272,970

(22) Filed: Nov. 15, 2005

(30) Foreign Application Priority Data
Nov. 16, 2004 (KR) 10-2004-0093503

(51) Int. Cl. G09G 3/28

(52) U.S. Cl. 345/67

(57) ABSTRACT

A plasma display panel including an upper substrate and a lower substrate facing each other; barrier ribs arranged between the upper and lower substrates to define a plurality of discharge cells together with the upper and lower substrates; a discharge sustain electrode pair extending along discharge cells arranged in a first direction, and including a scan electrode and a sustain electrode arranged in parallel with each other; a floating electrode arranged between the scan electrode and the sustain electrode and electrically floated; an address electrode extending in a second direction of crossing the first direction; a phosphor layer arranged in the discharge cells; and a discharge gas filled in the discharge cells.

### CROSS-REFERENCE TO RELATED APPLICATIONS

This application claims priority to and the benefit of Korean Patent Application No. 10-2004-0093503, filed on Nov. 16, 2004, which is hereby incorporated by reference for all purposes as if fully set forth herein.

### BACKGROUND OF THE INVENTION

1. Field of the Invention

The present invention relates to a plasma display panel, and more particularly, to a plasma display panel structure permitting fewer driving circuit boards.

2. Discussion of the Background

Generally, a plasma display panel (PDP) is a flat panel display that displays images using gas discharge. The PDP is highlighted as a next generation flat panel display to replace the cathode ray tube (CRT) since it has excellent display characteristics such as display capacity, brightness, contrast, residual image, and viewing angle.

FIG. 1 is a view of a structure of a conventional PDP. In the PDP of FIG. 1, barrier ribs 24 extend in transverse and longitudinal directions to define a plurality of discharge cells 30, and sustain electrode pairs, including scan electrodes Y1:Ym and sustain electrodes X1:Xm, are disposed along the discharge cells 30 that are arranged in a predetermined direction. For example, one scan electrode Y1 and one sustain electrode X1 form a discharge sustain electrode pair. Additionally, address electrodes A1:An are disposed along the discharge cells 30 that are arranged in a direction crossing the discharge sustain electrode pairs. A Y driving unit and an X driving unit apply driving signals to the scan electrodes Y1:Ym and the sustain electrodes X1:Xm, respectively, and an address driving unit applies address signals to the address electrodes A1:An.

FIG. 2 illustrates a conventional method for driving the PDP of FIG. 1. Referring to FIG. 2, the PDP may be driven by dividing one frame into a plurality of sub-fields SF in order to display various gray scale levels. A sub-field is divided into a reset period PR, an address period PA, and a sustain period PS. In the reset period PR, a ground voltage Vg is applied to all scan electrodes Y1:Ym prior to rapidly applying a sustain voltage Vs to the scan electrodes Y1:Ym. A rising ramp signal is then applied to the scan electrodes Y1:Ym to increase the voltage from the sustain voltage Vs as much as a predetermined voltage Vset, thus reaching the peak voltage Vs+Vset. Next, the voltage is rapidly decreased from the peak voltage Vs+Vset to the sustain voltage Vs, and then a falling ramp signal is applied to decrease the voltage applied to the scan electrodes Y1:Ym to the voltage V′nf. Additionally, the sustain electrodes X1:Xm are biased at the ground voltage Vg during the rising ramp signal, and then they are biased at the bias voltage Vb for the remainder of the reset period PR. The address electrodes A1:An are biased the ground voltage Vg during the reset period PR.

In the address period PA, scan pulses of a low scan voltage V′scl are sequentially applied to the scan electrodes Y1:Ym that are biased at a high scan voltage V′sch, and simultaneously, address signals are applied to the address electrodes A1:An. The address signals applied to the address electrodes A1:An include an address voltage Va of positive polarity to select the corresponding discharge cell, and the ground voltage Vg when the corresponding discharge cell is not to be selected. Accordingly, when the positive address voltage Va is applied simultaneously with the low scan voltage V′scl, an address discharge occurs between the scan and address electrodes of the corresponding discharge cell, thereby forming wall charges.

In the sustain period PS, sustain pulses having the sustain voltage Vs and the ground voltage Vg are alternately applied to all scan electrodes Y1:Ym and sustain electrodes X1:Xm. Thus, sustain discharge is generated in the discharge cells in which the wall charges are formed during the address period PA.

According to the conventional art, since the sustain pulses are applied to the scan electrodes Y1:Ym and the sustain electrodes X1:Xm, the Y driving unit and the X driving unit (refer to FIG. 1) are included to apply driving signals to the scan electrodes Y1:Ym and the sustain electrodes X1:Xm, respectively. However, since these driving units are typically formed of circuit boards having a plurality of mounted circuit devices, costs for fabricating the display apparatus increase because the circuit boards are expensive.

Furthermore, the circuit boards forming the driving units generate a lot of heat, and if the heat is not removed rapidly, it may degrade the circuit devices, which makes it difficult to drive the panel sufficiently. Therefore, an additional heat dissipation unit may be required. Moreover, the driving units may generate noise and vibration. If the noise and vibration are transmitted outside of the panel, the panel's quality is degraded and an additional unit may be required to block the noise and vibration.

### SUMMARY OF THE INVENTION

The present invention provides a PDP with fewer driving circuit boards that may still provide a substantially uniformly bright discharge operation.

Additional features of the invention will be set forth in the description which follows, and in part will be apparent from the description, or may be learned by practice of the invention.

The present invention discloses a PDP including an upper substrate and a lower substrate facing each other, and barrier ribs arranged between the upper and lower substrates to define a plurality of discharge cells together with the upper and lower substrates. A discharge sustain electrode pair extends along discharge cells arranged in a first direction and includes a scan electrode and a sustain electrode arranged substantially in parallel with each other. A floating electrode is arranged between the scan electrode and the sustain electrode and is electrically floated. An address electrode extends in a second direction crossing the first direction, a phosphor layer is arranged in the discharge cells, and a discharge gas is included in the discharge cells.

The present invention also discloses a PDP including a first substrate and a second substrate facing each other, and a plurality of discharge cells arranged between the first is substrate and the second substrate. A discharge cell includes a sustain discharge unit for generating a sustain discharge, and the sustain discharge unit includes a first electrode, a second electrode, and a third electrode. The third electrode is arranged between the first electrode and the second electrode and is electrically floated.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic plan view of a conventional PDP.

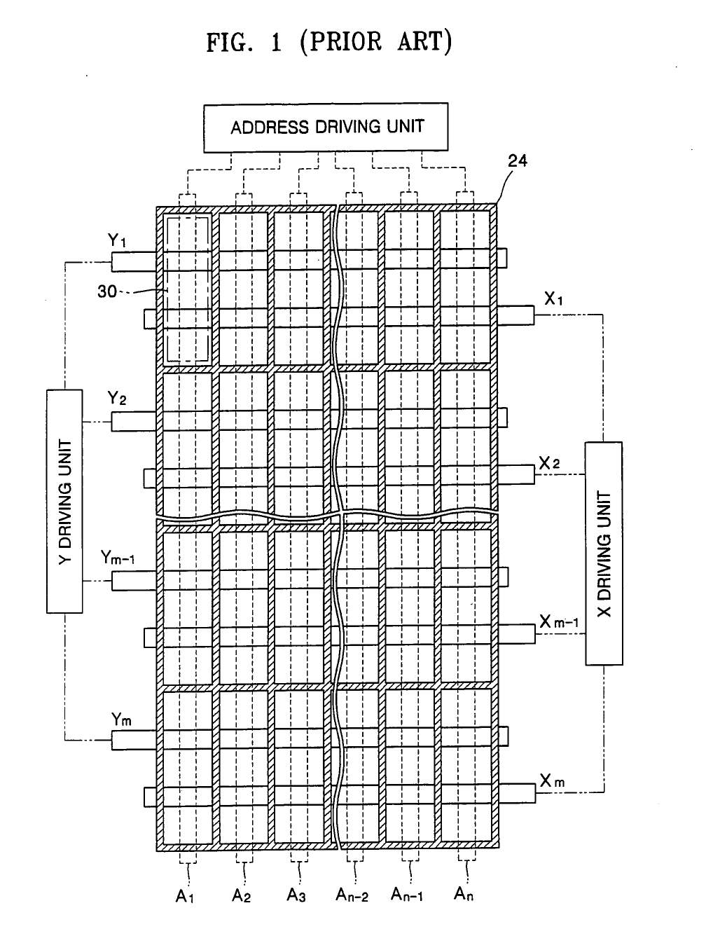

FIG. 2 is a view illustrating a conventional method for driving the PDP of FIG. 1.

FIG. 3 is an exploded perspective view of a PDP according to an embodiment of the present invention.

FIG. 4 is a cross-sectional view of the PDP taken along line IV-IV of FIG. 3.

FIG. 5 is a schematic plan view of a structure of the PDP of FIG. 3.

FIG. 6 is a view of brightness variation according to position at a discharge cell formed on a PDP.

FIG. 7 is a view illustrating a method for driving the PDP of FIG. 5.

FIG. 8 is a schematic exploded perspective view of a PDP according to another embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

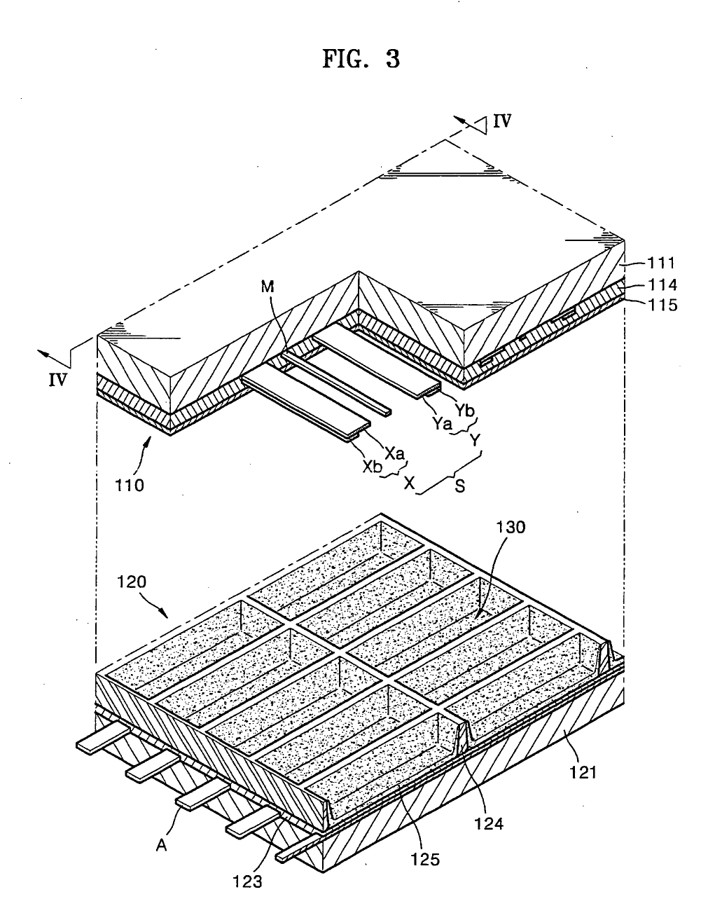

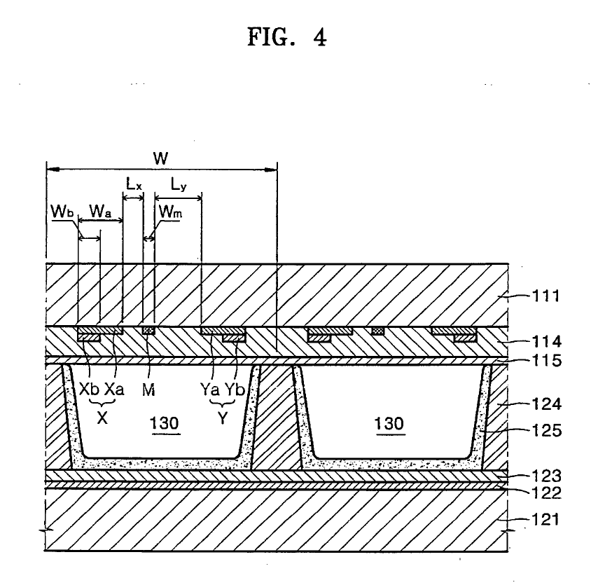

FIG. 3 is an exploded perspective view of a plasma display panel (PDP) according to an embodiment of the present invention, and FIG. 4 is a cross-sectional view of the PDP taken along line IV-IV of FIG. 4. Referring to FIG. 3, the PDP includes an upper panel 110 and a lower panel 120 that faces the upper panel 110 and is coupled with the upper panel 110. The upper panel 110 includes an upper substrate 111, a plurality of discharge sustain electrode pairs S arranged on a lower surface of the upper substrate 111 in a predetermined pattern, an upper dielectric layer 114 covering the discharge sustain electrode pairs S, and a protective layer 115 covering the upper dielectric layer 114.

The upper substrate 111 may be formed of a transparent material mainly including glass. The discharge sustain electrode pairs S are arranged on the lower surface of the upper substrate 111 in a predetermined pattern, for example, in a stripe pattern extending in a predetermined direction. Each discharge sustain electrode pair S includes a scan electrode Y and a sustain electrode X that are arranged substantially in parallel with each other. The scan electrode Y and the sustain electrode X include transparent electrodes Ya and Xa and bus electrodes Yb and Xb, respectively. Alternatively, the scan electrode Y and the sustain electrode X may include only the bus electrodes. The transparent electrodes Ya and Xa are formed of a transparent conductive material for generating a discharge without substantially blocking light emitted by a phosphor layer 125 to be transmitted through the upper substrate 111. For example, the transparent material may comprise indium tin oxide (ITO). The bus electrodes Yb and Xb are formed to enhance the conductivity of the transparent electrodes Ya and Xa, and they may be formed directly on the transparent electrodes Ya and Xa. The bus electrodes Yb and Xb are formed of a highly conductive metal, such as, for example, a single metal layer of Al or Ag, or a three-layered metal layer of Cr—Cu—Cr. The bus electrodes Yb and Xb may be narrower than the transparent electrodes Ya and Xa to reduce the amount of light they block. For example, as shown in FIG. 4, the width Wa of the transparent electrodes Ya and Xa may be about 100 to 120 μm, and the width Wb of the bus electrodes may be about 70 to 80 μm, when a pitch W between barrier ribs 124 defining the discharge cells 130 is about 320 to 350 μm.

At least one floating electrodes M may be arranged between the scan electrode Y and the sustain electrode X of each discharge sustain electrode pair S. The floating electrode M is continuously formed along a row of the discharge cells 130. In other words, the floating electrode M is arranged substantially in parallel with the scan electrode Y and the sustain is electrode X. The floating electrode M is electrically floated (i.e. not directly connected to a power source), and an induced voltage having a voltage level between that of the scan electrode Y and the sustain electrode X is formed at the floating electrode M. Since a constant voltage is maintained at the sustain electrode X when driving the PDP according to an embodiment of the present invention, the magnitude of the induced voltage increases and decreases according to a change of the driving voltage applied to the scan electrode Y. When the induced voltage is formed at the floating electrode M, priming particles in the discharge cell 130 move actively. Thus, formation of charged particles is accelerated, and the discharge is activated. The floating electrode M may be formed of a highly conductive material, such as, for example, a single metal layer of Al or Ag, or a three-layered metal layer of Cr—Cu—Cr, same as the bus electrodes Yb and Xb of the scan and sustain electrodes Y and X. When the floating electrode M is formed of the same material as the bus electrodes Yb and Xb, the bus electrodes Yb and Xb and the floating electrode M can be patterned simultaneously. In this case, the floating electrode M may be coplanar with the transparent electrodes Ya and Yb, as FIG. 4 shows, or the floating electrode M may be coplanar with the bus electrodes Yb and Xb. However, when the floating electrode M is formed of an opaque metal, the width Wm of the floating electrode M may be about 50 to 65 μm in consideration of the permeability of visible light. Additionally, the floating electrode M can be formed of a transparent conductive material such as, for example, ITO so as not to substantially interfere with light passing through the upper substrate 111.

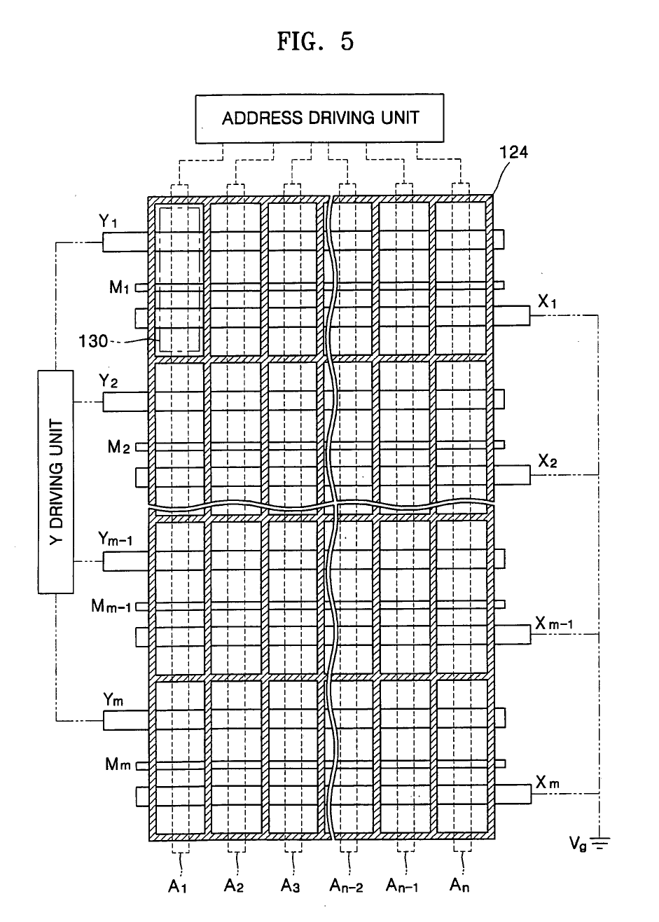

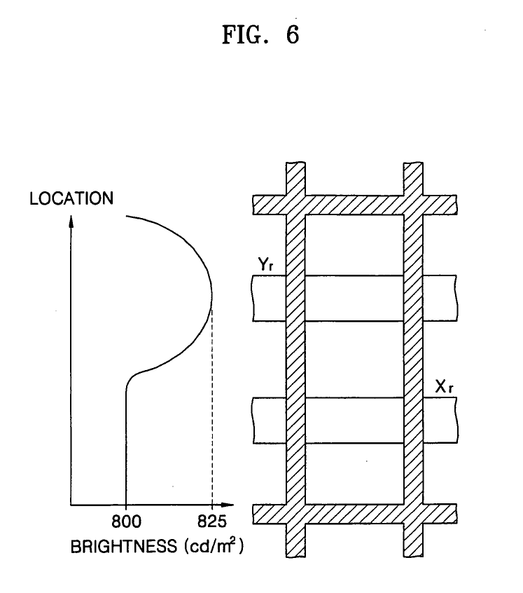

FIG. 5 is a view showing an electrode arrangement of the PDP of FIG. 3. Referring to FIG. 5, the scan electrodes Y1:Ym are coupled with the Y driving unit to receive driving signals, and the address electrodes A1:An are coupled with the address driving unit to receive address signals. However, a constant voltage of predetermined magnitude such as, for example, ground voltage Vg, is applied to the sustain electrodes X1:Xm. Consequently, and an X driving unit for applying driving signals to the sustain electrodes X1:Xm is not required. That is, in order to display an image in the sustain period, sustain pulses of predetermined alternating voltages are applied to the scan electrodes Y1:YM while biasing the sustain electrodes X1:Xm at ground voltage Vg. Therefore, if just utilizing the scan and sustain electrodes, the discharge occurs actively in the vicinity of the scan electrodes Y1:Ym, however, a weaker discharge occurs in the vicinity of the sustain electrodes X1:Xm. Thus, each discharge cell 130 may have different brightness levels at the portion where the scan electrodes Y1:Ym are arranged and at the portion where the sustain electrodes X1:Xm are arranged. FIG. 6 shows one PDP discharge cell having the scan electrode Yr facing the sustain electrode Xr. As FIG. 6 shows, the brightness level at the portion where the scan electrode Yr is arranged is about 825 cd/m², however, the brightness level at the portion where the sustain electrode Xr is arranged is about 800 cd/m². Therefore, the entire brightness level may be reduced, and image quality may be degraded by smudges on the image caused by the asymmetric light emission and the brightness variance.

In order to solve this problem, the floating electrode may be arranged between the scan electrode and the sustain electrode to reinforce the electric field at the sustain electrode side of the discharge cell 130, thereby accelerating the discharge in the vicinity of the sustain electrode. Hence, the floating electrode may be arranged closer to the sustain electrode than the scan electrode. More specifically, as FIG. 4 shows, a distance Lx between the floating electrode M and the sustain electrode X is less than a distance Ly between the floating electrode M and the scan electrode Y.

Referring to FIG. 3, an upper dielectric layer 114 substantially covers the scan electrodes Y and the sustain electrodes X. The upper dielectric layer 114 insulates adjacent scan and sustain electrodes Y and X from each other, and it protects the discharge sustain electrode pairs S from damage from collisions with positive ions or electrons during discharge. Additionally, the upper dielectric layer 114 induces electric charges.

The protective layer 115 may cover the upper dielectric layer 114. The protective layer 115 prevents positive ions or electrons from colliding with the upper dielectric layer 114 during discharge, and it emits secondary ions. Generally, the protective layer 115 may include an MgO layer.

Additionally, the lower panel 120 includes a lower substrate 121, a plurality of address electrodes A formed on the lower substrate 121 in a predetermined pattern, a lower dielectric layer 123 substantially covering the address electrodes A, barrier ribs 124 formed on the lower dielectric layer 123 to define a plurality of discharge cells 130, and a phosphor layer 125 formed on the upper surface of the lower dielectric layer 123 and sides of the barrier ribs 124.

The lower substrate 121 may be formed of a glass material, like the upper substrate 111. The address electrodes A extend in a stripe pattern and in a direction crossing the discharge sustain electrode pairs S. The lower dielectric layer 123 substantially covers the address electrodes A. The lower dielectric layer 123 protects the address electrodes A from being damaged by charged particles that may otherwise collide with the address electrodes A.

The barrier ribs 124 define the spaces where the phosphor layer 125 are arranged, and they prevent cross talk from occurring between adjacent discharge cells 130. The barrier ribs 124 define a plurality of discharge cells 130, which may be formed in matrix pattern as shown in FIG. 3.

The phosphor layer 125 is formed in the discharge cells 130. The phosphor layer 125 may be formed by applying a red, green, or blue phosphor material onto the discharge cells 130. The discharge cells 130 may be divided into red, green, and blue discharge cells according to the color of phosphor material therein. Although not shown in the drawings, a discharge gas is included in the discharge cells 130.

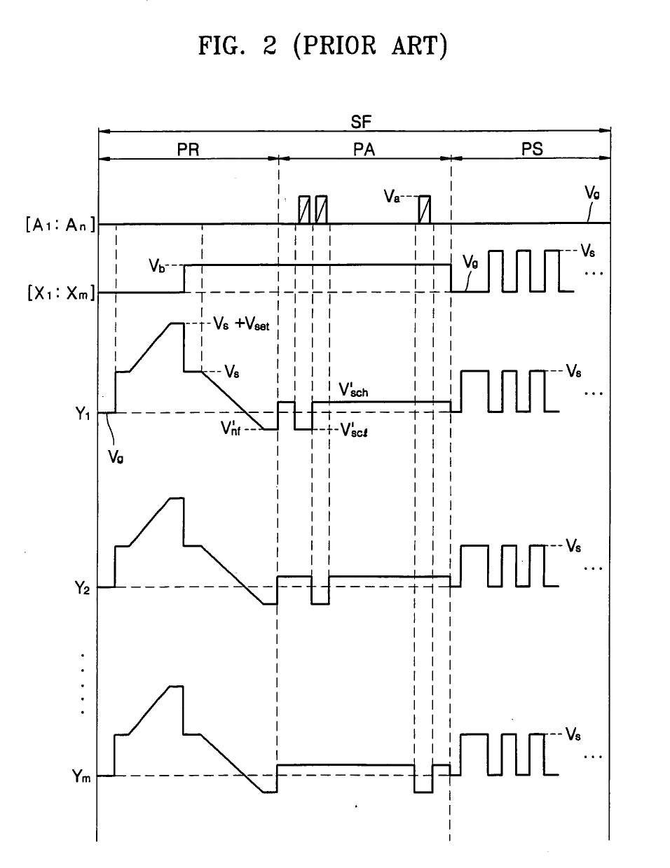

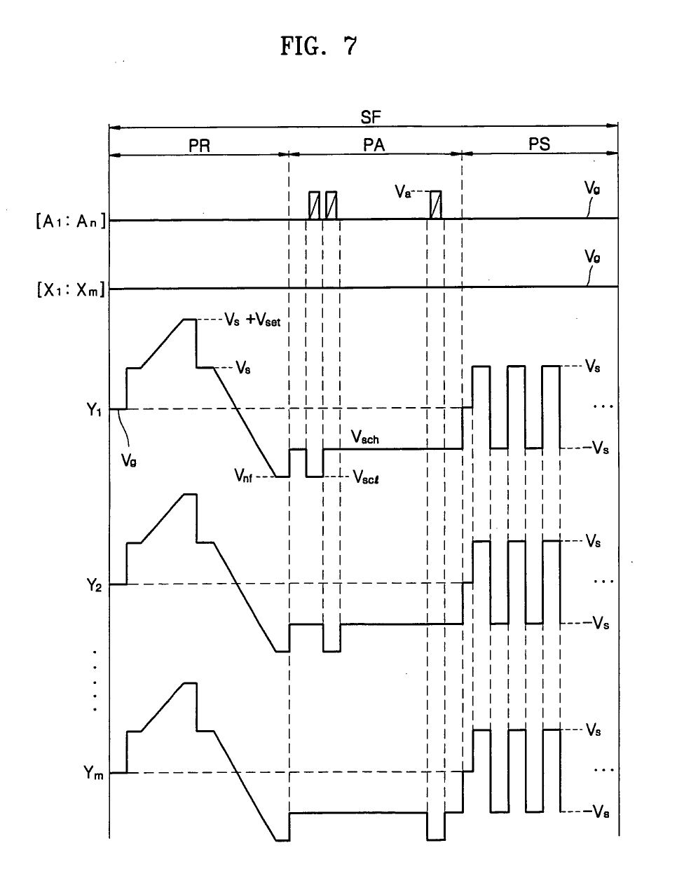

A method for driving the PDP of FIG. 5 will be described in detail below with reference to FIG. 7. Referring to FIG. 7, a frame may be divided into a plurality of sub-fields SF, and a subfield may include a reset period PR, an address period PA, and a sustain period PS that are performed sequentially. In the reset period PR, sustain voltage Vs is rapidly applied to the scan electrodes Y1:Ym from the ground voltage Vg. A rising ramp signal is then applied to the scan electrodes Y1:Ym to increase the voltage of the scan electrodes Y1:Ym as much as a predetermined voltage Vset from the sustain voltage Vs, thus reaching the peak voltage (Vs+Vset). Accordingly, a weak-strength discharge is generated by the rising ramp signal, thereby accumulating negative electric charges near the scan electrodes Y1:Ym. The sustain voltage Vs is then rapidly applied to the scan electrodes Y1:Ym, and a falling ramp signal is applied to the scan electrodes Y1:Ym to decrease the voltage from the sustain voltage Vs to the voltage Vnf. Here, the ground voltage Vg is applied to the sustain electrodes X1:Xm during the rising and falling ramp signals. Thus, bias voltage Vb, which is applied to the sustain electrodes in the conventional driving method of FIG. 2, should be compensated. Therefore, according to an embodiment of the present invention, the falling ramp signal applied to the scan electrodes Y1:Ym may have a steeper slope than that of the conventional art, and the lowest falling voltage Vnf may be lower than that of the conventional art.

Since the falling ramp signal is applied to the scan electrodes Y1:Ym, the discharge occurs, and consequently, some of the negative electric charges accumulated on the scan electrodes Y1:Ym are emitted. Thus, a suitable amount of negative electric charges for generating an address discharge remain near the scan electrodes Y1:Ym. Additionally, a constant voltage of a constant level, for example, ground voltage Vg, is applied to the sustain electrodes X1:Xm and the address electrodes A1:An during the reset period PR. The reset period PR provides substantially uniform electric charges for all discharge cells.

Next, in the address period PA, predetermined wall charges are formed on the selected discharge cells. The scan pulses of low scan voltage Vscl are sequentially applied to the scan electrodes Y1:Ym, which are biased at high scan voltage Vsch, and the address signals are applied to the address electrodes A1:An corresponding to the scan pulses. The address signals of address voltage Va are applied to the address electrodes A1:An to select the corresponding discharge cell, and the ground voltage Vg is applied to the address electrodes A1:An if the corresponding cell is not to be selected. Additionally, the sustain electrodes X1:Xm are biased at the ground voltage Vg like in the reset period PR. To select discharge cells 130, the address discharge is performed by the address voltage Va applied to the address electrodes A1:An, the low scan voltage Vscl applied to the scan electrodes Y1:Ym, wall charges caused by negative electric charges accumulated near the scan electrodes Y1:Ym, and wall charges caused by positive electric charges accumulated near the address electrodes A1:An. As a result of the address discharge, positive electric charges accumulate near the scan electrodes Y1:Ym and negative electric charges accumulate near the sustain electrodes X1:Xm.

During the sustain period PS, predetermined sustain pulses are applied to the scan electrodes Y1:Ym to generate sustain discharge at the discharge cells where wall charges are accumulated (i.e. selected discharge cells). That is, sustain pulses having positive sustain voltage Vs and negative sustain voltage Vs are alternately applied to the scan electrodes Y1:Ym. Thus, the wall voltage formed by address discharge plus the sustain voltage Vs exceed a discharge firing voltage, thereby generating sustain discharge. Additionally, the sustain electrodes X1:Xm and the address electrodes A1:An are biased at the ground voltage Vg during the sustain period PS.

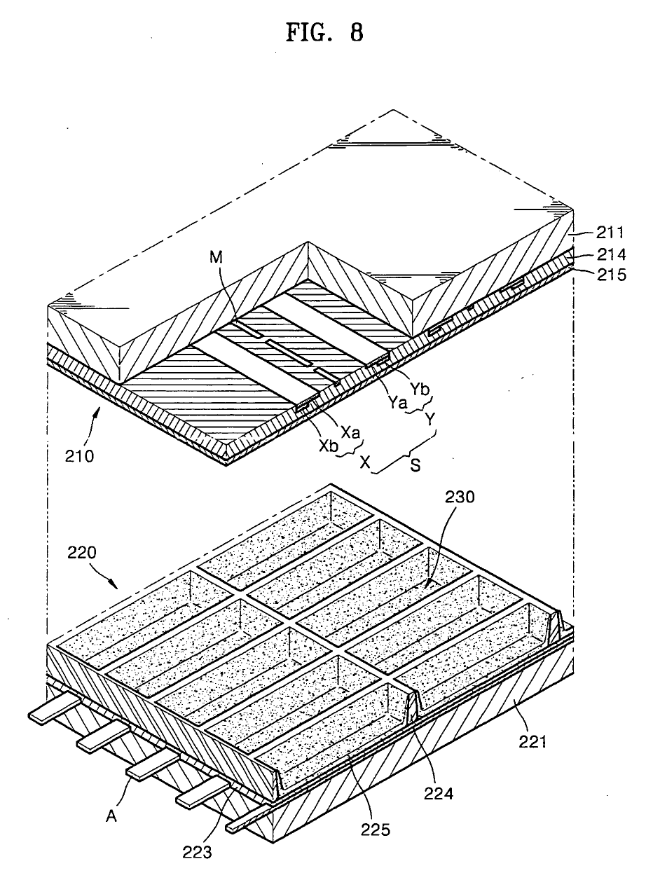

FIG. 8 is an exploded perspective view of a PDP according to a second embodiment of the present invention. Referring to FIG. 8, the PDP of the second embodiment includes barrier ribs 224 partitioning the space between upper and lower substrates 211 and 221 into a plurality of discharge cells 230, discharge sustain electrode pairs S including a scan electrode Y and a sustain electrode X extending along a row of the discharge cells 230, and a floating electrode M arranged between the scan electrode Y and the sustain electrode X. In the present embodiment, the floating electrode M is not continuously formed along a row of the discharge cells 230. Rather, the floating electrode M is independently formed at each discharge cell 230. The floating electrode M is closer to the sustain electrode X than the scan electrode Y as described in the above embodiment. Thus, the floating electrode M reinforces the electric field in the vicinity of the sustain electrode X and activates the discharge operation.

An upper panel 210 including an upper dielectric layer 214 and a protective layer 215, and a lower panel 220 including address electrodes A, a lower dielectric layer 223, and a phosphor layer 225 may be substantially the same as those of the first embodiment, and their detailed descriptions will be omitted.

According to embodiment of the present invention, the PDP may be driven using fewer circuit boards than the conventional art. Therefore, the fabrication costs for the PDP including the circuit boards may be significantly reduced, and costs and processes for designing the heat dissipation structure of the circuit board or removing vibrations may be reduced.

Furthermore, the brightness difference on the display panel due to an uneven discharge may be reduced or removed. That is, since the floating electrode is arranged adjacent to the sustain electrode, the electric field in the vicinity of the sustain electrode may have a discharge intensity that is substantially similar to that of the scan electrode.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
an upper substrate and a lower substrate facing each other;
barrier ribs arranged between the upper substrate and lower substrate to define a plurality of discharge cells together with the upper substrate and the lower substrate;
a discharge sustain electrode pair extending along discharge cells arranged in a first direction, the discharge sustain electrode pair including a scan electrode and a sustain electrode arranged substantially in parallel with each other;
a floating electrode arranged between the scan electrode and the sustain electrode, the floating electrode being electrically floated;
an address electrode extending in a second direction crossing the first direction;
a phosphor layer arranged in the discharge cells; and
a discharge gas in the discharge cells.

2. The PDP of claim 1, wherein the floating electrode is continuously formed extending along the discharge cells arranged in the first direction.

3. The PDP of claim 1, wherein the floating electrode is separately arranged at each discharge cell arranged in the first direction.

4. The PDP of claim 1, wherein the floating electrode is arranged closer to the sustain electrode than to the scan electrode.

5. The PDP of claim 1, wherein the scan electrode and the sustain electrode each comprise a transparent electrode comprising a transparent conductive material and a bus electrode comprising a metal that contacts the transparent electrode, and the floating electrode comprises a metallic electrode.

6. The PDP of claim 5, wherein the floating electrode is arranged coplanar with the transparent electrodes.

7. The PDP of claim 5, wherein the floating electrode is arranged coplanar with the bus electrodes.

8. The PDP of claim 1, wherein the discharge sustain electrode pair is substantially covered by an upper dielectric layer, and the address electrode is substantially covered by a lower dielectric layer.

9. The PDP of claim 8, wherein the discharge sustain electrode pair and the floating electrode are arranged on a surface of the upper substrate, and a protective layer covers the upper dielectric layer.

10. The PDP of claim 8, wherein the address electrode is arranged on a surface of the lower substrate, and the phosphor layer is arranged on an upper surface of the lower dielectric layer and a side surface of a barrier rib.

11. The PDP of claim 1, wherein the PDP is driven by performing a series of driving periods including a reset period, an address period, and a sustain period, and a constant voltage is applied to the sustain electrode through the driving periods.

12. The PDP of claim 11, wherein the constant voltage is a ground voltage.

13. A plasma display panel (PDP), comprising:
a first substrate and a second substrate facing each other; and
a plurality of discharge cells arranged between the first substrate and the second substrate, a discharge cell including a sustain discharge unit for generating a sustain discharge,
wherein the sustain discharge unit comprises a first electrode, a second electrode, and a third electrode, the third electrode being arranged between the first electrode and the second electrode and being electrically floated.

14. The PDP of claim 13, wherein the first electrode, the second electrode, and the third electrode extend substantially in parallel with each other and along discharge cells arranged in a first direction, the first electrode, the second electrode, and the third electrode being continuously formed along the discharge cells arranged in the first direction.

15. The PDP of claim 13, wherein the first electrode, the second electrode, and the third electrode extend substantially in parallel with each other and along discharge cells arranged in a first direction, the first electrode and the second electrode being continuously formed along the discharge cells arranged in the first direction and the third electrode being independently formed at each discharge cell arranged in the first direction.

16. The PDP of claim 13, further comprising:
a fourth electrode arranged extending in a second direction crossing the first direction,
wherein an address discharge to select a discharge cell occurs between the first electrode and the fourth electrode, and the third electrode is arranged closer to the second electrode than to the first electrode.

17. The PDP of claim 16, wherein the first electrode and the second electrode each comprise a transparent electrode and a metallic electrode that contacts the transparent electrode, and the third electrode comprises a metallic electrode.

18. The PDP of claim 17, wherein the first electrode, the second electrode, and the third electrode are arranged on a surface of the first substrate and are substantially covered by a first dielectric layer, and the fourth electrode is arranged on a surface of the second substrate and is substantially covered by a second dielectric layer.

19. A method for driving the PDP of claim 13, wherein a frame is divided into a plurality of subfields, a subfield including a reset period, an address period, and a sustain period, the method comprising:
in the reset period,
applying a voltage to the first electrode that increases from a first level to a second level to generate a first discharge and then decreases from a third level to a fourth level to generate a second discharge; and
biasing the second electrode at a fifth level throughout the reset period.

20. The method of claim 19, further comprising:
in the sustain period,
applying a voltage to the first electrode that alternates between a sixth level and a seventh level, the sixth level and the seventh level having substantially the same magnitude but opposite polarity; and
biasing the second electrode at the fifth level throughout the sustain period.
